(19) United States
(12) Patent Application Publication
(10) Pub. No.: US 2014/0153435 A1
(43) Pub. Date: Jun. 5, 2014

(54) TIERED DEEP PACKET INSPECTION IN NETWORK DEVICES

(71) Applicants: James Rolette, Round Rock, TX (US); Bruce E. LaVigne, Roseville, CA (US); Joseph A. Curcio, Folsom, CA (US)

(72) Inventors: James Rolette, Round Rock, TX (US); Bruce E. LaVigne, Roseville, CA (US); Joseph A. Curcio, Folsom, CA (US)

(21) Appl. No.: 14/235,112

(22) PCT Filed: Aug. 31, 2011
(86) PCT No.: PCT/US2011/050088

§ 371 Date: Jan. 27, 2014

(51) Int. Cl. H04L 12/26

(52) U.S. Cl. CPC H04L 43/062
USPC 370/252

(57) ABSTRACT

Packet inspection in a network device includes a first stage circuit to monitor packets being switched by a network interface in the network device. The first stage circuit includes at least one pattern matcher to identify selected flows in the packets satisfying first criteria and to divert the selected flows from standard processing in the network interface. A second stage circuit receives the selected flows, performs deep packet inspection on the selected flows to identify further selected flows satisfying a second criteria, and controls the network interface to apply alternative processing to the further selected flows and allow the selected flows other than the further selected flows to rejoin the standard processing.

### BACKGROUND

Mobile computing is becoming ubiquitous. Notebook computers, personal digital assistants (PDAs), mobile telephones, touch pads, and the like are in widespread use on both personal and business levels. As a result, malicious software (“malware”) is likewise becoming mobile and spreading as infected mobile devices connect to different networks. In a network environment, securing the perimeter and core of the network is no longer sufficient. Mobile computing devices alternate between unsecured home wireless networks and the interior of corporate networks. Universal Serial Bus (USB) flash drives infected with malware can compromise computers and servers on the network. Network security beyond authorization and access control is required to detect and mitigate malware introduced into the network by such mobile devices. While some network security appliances can perform this task, they are too expensive and impractical to deploy at an access layer of the network. Performance of add-on security modules and blades for existing switches are too low by multiple orders of magnitude.

### BRIEF DESCRIPTION OF THE DRAWINGS

Some embodiments of the invention are described with respect to the following figures:

FIG. 1 is a block diagram of a network device according to an example implementation;

FIG. 2 is a block diagram depicting a network device according to another example implementation;

FIG. 3 is a block diagram depicting a switch node according to an example implementation;

FIG. 4 is a block diagram depicting a network processor according to an example implementation; and

FIG. 5 is a flow diagram depicting a method of packet inspection in a network device according to an example implementation.

### DETAILED DESCRIPTION

Tiered deep packet inspection (DPI) in network devices is described. An embodiment relates to packet inspection in a network device. A first stage circuit monitors packets being switched by a network interface of the network device. The first stage circuit includes at least one pattern matcher to identify selected flows in the packets satisfying first criteria. The first stage circuit diverts the selected flows from standard processing in the network interface. A second stage circuit receives the selected flows. The second stage circuit performs DPI on the selected flows to identify further selected flows satisfying second criteria. The second stage circuit controls the network interface to apply alternative processing to the further selected flows, and allow the selected flows other than the further selected flows to rejoin the standard processing. Accordingly, those flows that do not satisfy the second criteria are released from diversion and allowed to flow through the network interface using the standard processing, and those flows that do satisfy the second criteria are released from diversion and the network interface uses alternative processing.

Examples of tiered DPI described herein can be used in various applications, such as security applications, traffic steering applications, and the like. To scale performance up to the levels required to process packets in a network switch, the packet inspection process is split into multiple tiers. A first tier of packet inspection can be implemented in a forwarding path of the network switch that is switching the packets (e.g., by a first stage circuit). Hence, the first tier can process packets to identify flows satisfying some defined criteria at the data-rate of the forwarding path switching the packets (“switching data-rate”). Packets that do not satisfy the defined criteria are forwarded through the switch at the switching data-rate without being affected by this first tier of packet inspection. Packets in the flows satisfying the defined criteria are diverted from standard processing and re-routed to at least one additional tier of packet inspection for further inspection (e.g., provided by a second stage circuit). The additional tier(s) can perform a deeper inspection of the re-routed flows to identify flows satisfying some additional criteria. The switch can process the flows satisfying the additional criteria using alternative processing, rather than the standard switching process.

The mufti-tiered packet inspection can be used to provide various security applications. In an example, the multi-tiered packet inspection can be used to provide an Intrusion Prevention System (IPS) in a network switch. The first tier detects packet flows that are suspicious, which are re-routed to additional tier(s). The additional tier(s) detect which of the suspicious flows are malicious. Malicious flows can then be processed using some alternative processing, such as being blocked within the switch, being redirected out particular port(s) of the switch, being mirrored to particular port(s) of the switch, or the like. In another type of security application, the multi-tiered packet inspection can be used to detect and specially handle traffic that includes confidential information. The first tier detects packet flows having potentially confidential information (e.g., packets including the text “confidential”, “secret”, etc.). The flows with potential confidential information are re-routed to additional tier(s). Additional tier(s) confirm which of those flows actually includes confidential information. The flows having confidential information can be handled differently (e.g., blocking, redirecting, mirroring, etc.). The multi-tiered packet inspection can be used to provide other types of non-security applications, such as traffic steering based on some attribute(s) of the traffic. The first tier detects packet flows that match some attribute(s), which are re-routed to additional tier(s). The additional tier(s) identify flows that match some additional attribute(s). The switch can apply different processing for packet flows identified by the additional tier(s) (e.g., redirection to different ports for load-balancing, mirroring, etc.).

By integrating inline packet inspection in a switch, traffic satisfying defined criteria can be specially handled at the point of entry to a network. Traffic identification and handling becomes part of the network infrastructure. Consider an IPS application, for example. When compared to only securing the perimeter or the core of the network, the integrated inline packet inspection reduces or eliminates the chance of the malware spreading to other systems. Network administrators do not have to rely on mobile devices having the most up-to-date end-point malware protection installed, or rely on users of the mobile devices to keep malware protection software up-to-date. While IPS appliances can perform DPI, it may be impractical or impossible to deploy such IPS appliances to process packets in a forwarding path of a switch without the IPS appliances becoming a bottleneck. This is particularly the case in high-speed enterprise switches that can have switching data-rates orders of magnitude higher than can be handled by the IPS appliance. The tiered packet inspection described herein scales to the levels required to inspect 100 percent of the traffic flowing through the forwarding path of a switch with little or no impact on the data-rate of the traffic. Various embodiments are described below by referring to several examples.

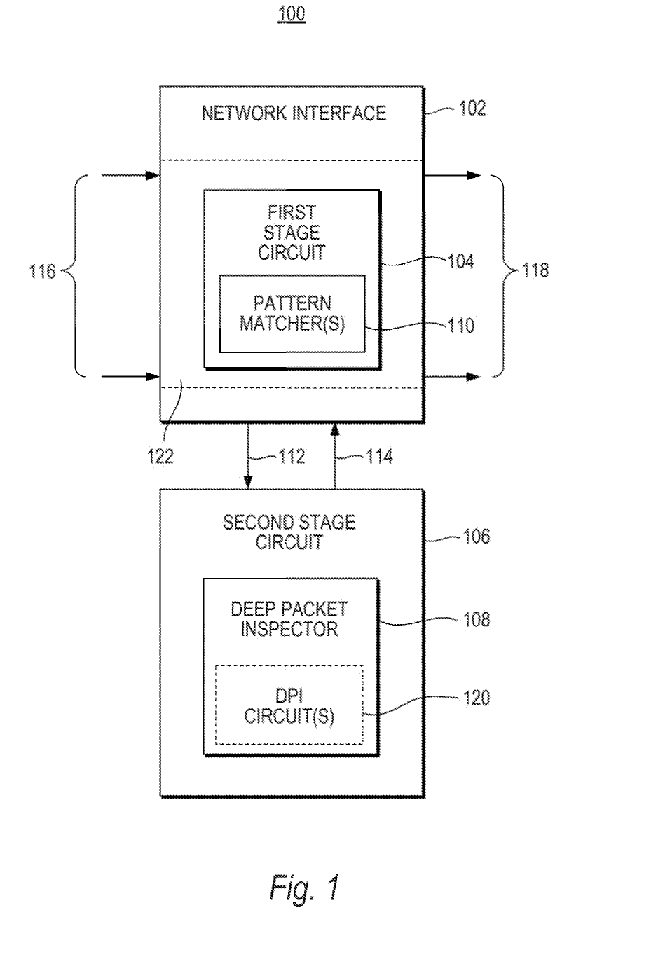

FIG. 1 is a block diagram of a network device 100 according to an example implementation. The network device 100 includes a network interface 102 having a first stage circuit 104, and a second stage circuit 106 having a deep packet inspector 108. The network interface 102 includes a plurality of inputs 116 and a plurality of outputs 118, The first stage circuit 104 includes at least one pattern matcher (“pattern matcher(s) 110”). The network device 100 includes a packet interface 112 and a control interface 114 between the network interface 102 and the second stage circuit 106.

The network interface 102 switches traffic from the inputs 116 among the outputs 118 using standard processing (e.g., a standard switch process based on source and destination addresses of the packets). Traffic includes packetized data (“packets”) formatted using multiple layers of protocol, e.g., the Transmission Control Protocol (TCP) Internet Protocol (IP) (“TCP/IP”) model, Open Systems Interconnection (OSI) model, or the like. A packet generally includes a header and a payload. The header implements a layer of protocol. The payload includes data, which may be related to packet(s) at another layer of protocol. In an example, the network interface 102 performs switching of the packets at a network access layer. The network access layer provides links between hosts over which packets are transmitted. The network access layer is sometimes referred to as layer 2, referring to layer 2 of the OSI model. The prevailing network access layer today includes the Ethernet family of protocols, although the network interface 102 can switch packets using other types of network access protocols. While the network interface 102 can switch traffic at the network access layer, the network interface 102 can also process packets at layers above the network access layer to implement various other functions (e.g., quality of service (QoS), such as at a network layer (e.g., IP or other 051 layer 3 protocol) and/or transport layer (e.g., TCP, User Datagram Protocol (UDP), or other OSI layer 4 protocol).

The first stage circuit 104 implements a first tier of packet inspection. The first stage circuit 104 monitors the packets being switched by the network interface 102. The first stage circuit 104 can be in the processing path of the network interface 102 that processes the packets as they flow from the inputs 116 to the outputs 118 (“forwarding path 122”). In general, the first stage circuit 104 identifies packets satisfying defined criteria and controls the network interface 102 to divert the identified packets from the standard processing. In an example, the first stage circuit 104 can be implemented as a packet filter in an integrated circuit (IC) that implements the network interface 102.

The pattern matcher(s) 110 identify flows in the packets received by the first stage circuit 104 satisfying some defined criteria (“selected flows” satisfying “first criteria”), A “flow” or (“packet flow” is a sequence of packets passing an observation point during a time interval, where the sequence includes at least one packet. In an example, a flow can include multiple packets that share common attributes, such as common source and destination IP addresses and port numbers (e.g., a “5-tuple” flow). The pattern matcher(s) 110 can establish criteria for packet flows deemed to indicate some defined activity (“first criteria”). As described below, the selected flows are further processed using deeper inspection to identify flows satisfying some additional defined criteria (“further selected flows” satisfying “second criteria”). The first stage circuit 104 diverts the selected flows from standard processing in the network interface 102. The first stage circuit 104 can re-route the selected flows to the second stage circuit 106.

In an example, the pattern matcher(s) 110 match the packets against defined patterns. In an example, the patterns include byte patterns. The pattern matcher(s) 110 can analyze a flow looking for particular byte patterns in the payloads and/or headers of the packets. If a flow includes a particular byte pattern (or some threshold number of byte patterns), then the pattern matcher(s) 110 deem the flow as satisfying the first criteria. In another example, the patterns include packet patterns. The pattern matcher(s) 110 can analyze a flow looking, for a particular pattern of packets, such as out-of-order packets in a TCP stream, a sequence of unusually small packets, and the like. If a flow includes a particular packet pattern (or some threshold number of packet patterns), then the pattern matcher(s) 110 deem the flow as satisfying the first criteria. In another example, the pattern matcher(s) 110 can match a combination of byte and packet patterns.

The pattern matcher(s) 110 perform a “limited-scope” inspection of the packets, which can allow the first stage circuit 104 to process packets at the switching data-rate of the forwarding path. The second stage circuit 106 receives only the selected flows re-routed from the network interface 102 over the packet interface 112. The second stage circuit 106 implements at least one additional tier of packet inspection, The second stage circuit 106 can include a deep packet inspector 108 to provide additional tier(s) of packet inspection. The deep packet inspector 108 performs DPI on the selected flows to identify further selected flows satisfying second criteria. The deep packet inspector 108 can include test(s) for packet flows, if a packet flow matches test criteria, then the deep packet inspector 108 deems the packet flow as satisfying the second criteria. In an example, the second stage circuit 106 can be implemented by at least one network processor that executes machine readable code to implement the deep packet inspector 108.

In an example, the deep packet inspector 108 analyzes the selected flows at multiple protocol layers, including data link, network, transport, application, or any combination of such protocol layers. Example functions performed by the deep packet inspector 108 during the test(s) include IP and TCP reassembly, TCP state tracking, normalization, protocol decoders, header and content rule engines, IP and Domain Name System (DNS) reputation evaluation, or like type deep packet inspection functions.

In an example, the deep packet inspector 108 is implemented using at least one DPI circuit 120. Each DPI circuit 120 can add a tier of packet inspection to the first tier of packet inspection provided by the first stage circuit 104. In an example, a single DPI circuit 120 provides all DPI to provide two tiers of packet inspection. In another example, the DPI is divided into a plurality of portions handled by a respective plurality of DPI circuits 120 to provide a plurality of packet inspection tiers. Each portion of DPI can include one or more functions described above.

The second stage circuit 106 provides control data to the network interface 102 over the control interface 114. The network interface 102 can keep track of packet flows in the traffic being switched. In an example, the network interface 102 can maintain data for the packet flows that indicates whether the packet flows should be processed using standard processing, diverted, or processed using alternative processing. The first stage circuit 104 can control the network interface 102 to divert those packet flows that satisfy the first criteria. The control data from the second stage circuit 106 can control the network interface 102 to release the selected flows from diversion to the second stage circuit 106. The control data can also control the network interface 102 to apply alternative processing to the further selected flows. Alternative processing can include blocking the further selected flows, re-directing the further selected flows to defined location(s) (e.g., to defined port(s)), mirroring the further selected flows to defined location(s) (e.g., to port(s) based on destination addresses, as well as to defined port(s)), metering the further selected flows, counting the further selected flows, or forwarding the further selected flows based on source/destination addresses, or some combination of such actions. For example, the alternative processing can include metering, counting, or the like of the further selected flows, and then forwarding the further selected flows according to their destination addresses.

In this manner, the network device 100 provides special handling of traffic that satisfies particular criteria (e.g., first and second criteria). The network device 100 performs multi-tiered packet inspection of the traffic to scale with the switching data-rate of the network interface 102 and the data-rate of the traffic, The first tier (e.g., the first stage circuit 104) performs limited-scope inspection at the switching data-rate, and the additional tier(s) (e.g., the second stage circuit 106) perform deeper inspection at a slower rate. Since the selected flows diverted from standard processing represent a fraction of the flows being switched, the additional tier(s) can perform the deeper inspection, a slower process, with little or no impact on the data-rate of the traffic.

The first and second criteria used in the first and additional tier(s) of packet inspection, respectively, can be defined in accordance with the desired application. For example, if the multi-tiered packet inspection is used to detect malware, the first criteria can be used to detect “suspicious” traffic, and the second criteria can be used to confirm whether any of the suspicious traffic is “malicious” traffic. The network interface 102 can then block, re-direct, or otherwise secure the malicious traffic using the alternative processing defined in the network interface 102 lithe network device 100 is deployed at an entry point of the network, malicious traffic is handled at the entry point before reaching further systems in the network (e.g., further client devices, server devices, network infrastructure devices, etc.). In another example, if the multi-tiered packet inspection is used to detect confidential information in the traffic, the first criteria can be used to detect certain indicators of confidential information (e.g., text having the words “confidential”, “secret”, or the like). The second criteria can be used to confirm whether the identified traffic includes confidential information. The network interface 102 can then block, re-direct, mirror, or the like the confidential traffic. If the network device 100 is deployed at an entry point of the network, the confidential traffic can be handled at the entry point before being spread to additional systems. In another example, the multi-tiered packet inspection is used to detect a particular type of traffic. The first criteria of the first tier is used to identify traffic having some first attribute(s), and the second criteria of the additional tier(s) is used to identify traffic having some additional attribute(s). The traffic satisfying these criteria can then be re-directed, mirrored, metered, counted, or the like.

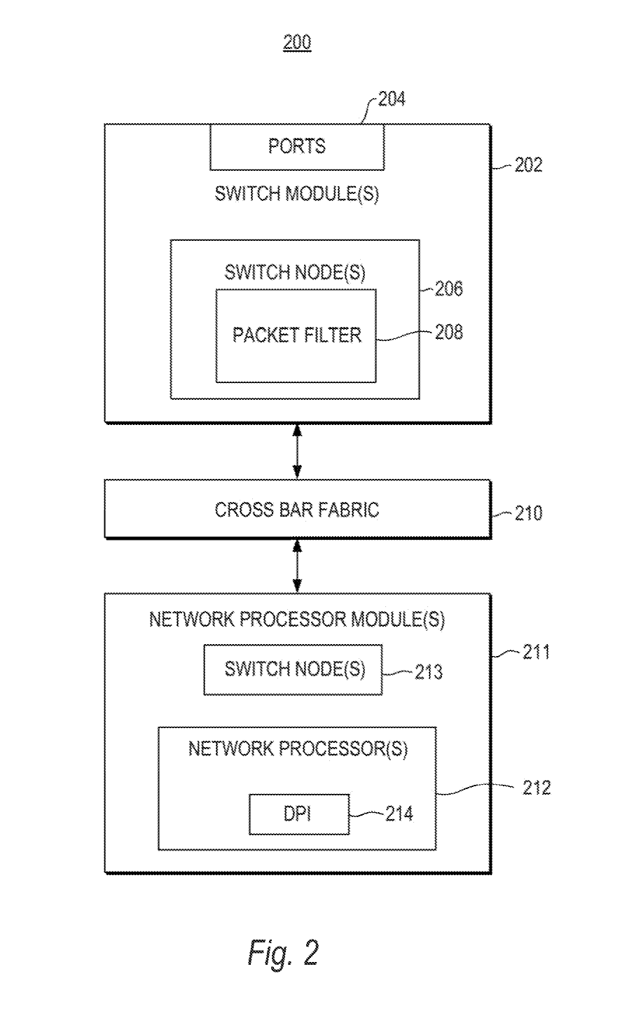

FIG. 2 is a block diagram depicting a network device 200 according to another example implementation. The network device 200 includes at least one switch module (“switch module(s) 202”), a crossbar fabric 210, and at least one network processor module (“network processor module(s) 211”). The switch module(s) 202 include ports 204 and at least one switch node (“switch node(s) 206”). Each of the switch node(s) 206 includes a packet filter 208. The network processor module(s) 211 include at least one switch node (“switch node(s) 213”) and at least one network processor (“network processor(s) 212”). The network processor(s) 212 include a deep packet inspector 214. The switch module(s) 202 and the network processor module(s) 211 are coupled to the crossbar fabric 210. The switch module(s) 202 and the network processor module(s) 211 can comprise “blades” supported in a chassis.

The network device 200 implements a multi-tiered packet inspection. The multi-tiered packet inspection is used to identify packet flows that satisfy some particular criteria. The particular criteria can be split into first criteria applied by a first tier of packet inspection, and second criteria applied by additional tier(s) of packet inspection. Flows that satisfy the first criteria are referred to as “selected flows”. Flows are “selected” for further analysis if they potentially satisfy the second criteria. Flows that satisfy the second criteria are referred to as “further selected flows”. The network device 200 handles flows that are not selected for further analysis using a standard policy. For example, non-selected flows are switched according to their destination addresses. The network device 200 handles selected flows by diverting the selected flows from the standard policy for deeper packet inspection by the additional tier(s) of inspection. Some selected flows may be further selected after additional analysis, while other selected flows may be “cleared” (“cleared flows”). The network device 200 can return the cleared flows to handling by the standard policy. The network device 200 can handle the further selected flows using an alternative policy.

The ports 204 communicate packets between network interfaces of host devices (not shown) over a physical layer (e.g., an Ethernet physical layer). The switch node(s) 206 switch packets over a network access layer (e.g., an Ethernet data link layer) at a switching data-rate. Some packets can travel from the ports 204, through a switch node 206, and back to the ports 204. Other packets can travel from the ports 204, through a switch node 206, through the crossbar fabric 210, through another switch node 206, and back to the ports 204. Within each of the switch node(s) 206, the packets being switched are processed by the packet filter 208.

The packet filter 208 implements a first tier of packet inspection. The packet filter 208 identifies flows satisfying first criteria (selected flows). The switch node(s) 206 divert the selected flows from being switched in accordance with the standard policy (e.g., based on destination address). The switch node(s) 206 re-route the selected flows to the network processor(s) 212. Thus, the selected flows travel from the ports 204, through a switch node 206, through the crossbar fabric 210, to the switch node(s) 213, and to the network processor(s) 212.

The network processor(s) 212 implement additional tier(s) of packet inspection using the deep packet inspector 214. The network processor(s) 212 perform DPI on the selected flows, through operation of the deep packet inspector 214, to identify flows satisfying second criteria (“further selected flows”). The network processor(s) 212 control the switch node(s) 206 and 213 to allow switching of the selected flows other than the further selected flows (e.g., cleared flows) based on the standard policy (e.g., such flows are re-forwarded to their original intended destinations) and process the further selected flows based on an alternative policy. The alternative policy can include blocking, re-directing, mirroring, metering, counting, and/or like type of alternative processing of the further selected flows, or any combination thereof.

In an example, the alternative policy dictates that the switch node(s) 206 and 213 block switching of the further selected flows among the ports 204. The switch node(s) 206 re-route the selected flows to the switch node(s) 213, and the network processor(s) 212 obtain the selected flows from the switch node(s) 213 to identify further selected flows and cleared flows after further DPI analysis, The network processor(s) 212 can control the switch node(s) 206 and 213 to block the further selected flows, and allow the cleared flows to be switched in accordance with the standard policy (e.g., routed to the switch node(s) 206 and out the ports 204). In another example, the alternative policy dictates that the switch node(s) 206 and 213 redirect or mirror the further selected flows to at least one specified port of the ports 204. In another example, the alternative policy dictates that the switch node(s) 206 and 213 perform one or more processes on the further selected flows before such flows are forwarded according the standard policy, redirected, or mirrored. Such processes can include metering, counting, like type handling of the further selected flows.

In an example, the network device 200 includes a single network processor 212. A single network processor can perform a second tier of packet inspection by performing complete DPI on all of the selected flows diverted by the switch node(s) 206.

In another example, the network device 200 includes a plurality of network processors 212. Multiple network processors 212 can be used in different configurations. In an example, each of a plurality of network processors 212 can perform a portion of DPI (e.g., a separate tier of packet inspection). The selected flows can be processed by at least one of the multiple network processors 212 (e.g., processed in at least one tier of DPI). Further selected flows can be identified after being processed by a threshold number of network processors 212 (e.g., processed over a threshold number of DPI tiers). In such a configuration, each successive tier of packet inspection processes fewer packets. The first tier packet inspection performed by the switch node(s) 206 identifies a fraction of the packets being switched for selection. A second tier of packet inspection performed by a network processor 212 can perform deeper packet inspection to identify some of the selected flows as cleared. Thus, the second tier can pass on a fraction of the selected flows to a third tier implemented by another network processor 212 and so on.

In another example, each of a plurality of network processors 212 can perform complete DPI on a portion of the selected flows. The switch node(s) 206 can divert a different portion of the selected flows to each of the network processors 212. In such a configuration, a second tier of packet inspection is performed by multiple network processors 212, which can increase processing throughput of the second tier. In another example, multiple network processors 212 can implement multiple tiers of packet inspection, with each tier including multiple network processors (e.g., a combination of the above-described configurations).

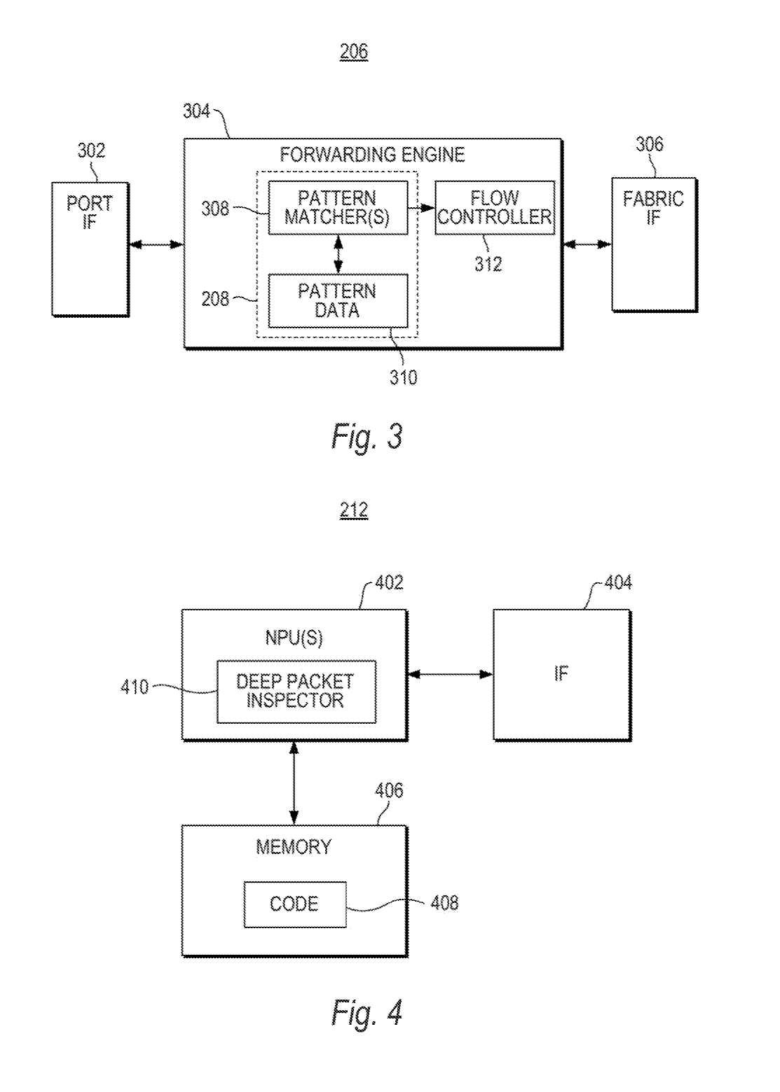

FIG. 3 is a block diagram depicting a switch node 206 according to an example implementation. Elements of FIG. 3 that are the same or similar to those of FIG. 2 are designated with identical reference numerals and described in detail above. The switch node 206 includes a port interface (IF) 302, a forwarding engine 304, and a fabric IF 306. The port IF 302 receives and transmits packets to the ports 204. The fabric IF 306 receives and transmits packets from the crossbar fabric 210. The forwarding engine 304 receives packets from the port IF 302, performs switching on the packets, and forwards the packets either to the port IF 302 or the fabric IF 306.

The forwarding engine 304 includes at least one pattern matcher (“pattern matcher(s) 308”), pattern data 310, and a flow controller 312. The pattern matcher(s) 308 and the pattern data 310 comprise the packet filter 208. The pattern data 310 includes a plurality of patterns. The patterns can be byte patterns and/or packet patterns and/or regular expressions. The pattern matcher(s) 308 match the packets against the patterns in the pattern data 310. The pattern matcher(s) 308 can be “stateful” in that patterns can be detected across packet boundaries (e.g., a pattern can extend across packets). Packet(s) matching pattern(s) are deemed to satisfy the first criteria (e.g., selected flows). In an example, the pattern matcher(s) 308 can include at least one Bloom filter. A Bloom filter can be used to test whether an element (e.g., a byte pattern from packet(s)) is a member of a set (e.g., interesting byte patterns). In another example, the pattern matcher(s) 308 can include a regular expression filter. A regular expression filter searches for byte patterns in the packets using regular expressions. In another example, the pattern matcher(s) 308 can include a packet order tracker that tracks ordering of packets (e.g., the order of packets in a TCP stream). In another example, the pattern matcher(s) 308 can include a packet size tracker that searches for packets that match suspicious packet sizes. The pattern matcher(s) 308 can include any combination of such examples, in addition to like type byte pattern and/or packet pattern matching devices. The pattern matcher(s) 308 control the flow controller 312 to divert the selected flows from the standard policy by re-routing the selected flows to the network processor(s) 212 for deeper packet inspection.

FIG. 4 is a block diagram depicting a network processor 212 according to an example implementation. Elements of FIG. 4 that are the same or similar to those of FIG. 2 are designated with identical reference numerals and described in detail above. The network processor 212 can include at least one network processing unit (NPU) (“NPU(s) 402”), an IF 404, and a memory 406. Each of the NPU(s) 402 includes any type integrated circuit (IC) that includes logic for processing packets. The IF 404 can receive packets from the switch node(s) 213 and can provide control data to the switch node(s) 213. The memory 406 can include random access memory, read only memory, content addressable memory (CAM) (e.g., ternary CAMs (TCAMs)), or the like or any combination of such memory devices.

The NPU(s) 402 implement a deep packet inspector 410 to provide deep packet inspection for the packets received through the IF 404. The memory 406 can store code 408, which has machine readable instructions executable by the NPU(s) 402 to implement the deep packet inspector 410. The deep packet inspector 410 can perform packet inspection at multiple protocol layers, including data link, network, transport, application, or any combination of such protocol layers. Example functions performed by the deep packet inspector 108 include IP and TCP reassembly, TCP state tracking, normalization, protocol decoders, header and content rule engines, IP and DNS reputation evaluation, or like type deep packet inspection functions. Using the functions, the deep packet inspector 410 can implement at least one test. If the selected flows match test criteria, then the deep packet inspector 410 further selects flows from the selected flows.

The deep packet inspector 410 can send control data identifying further selected and cleared flows to the switch nodes 213 that provided the selected flows. The deep packet inspector 410 can also send control data to another network processor for performing further deep packet inspection at another processing tier.

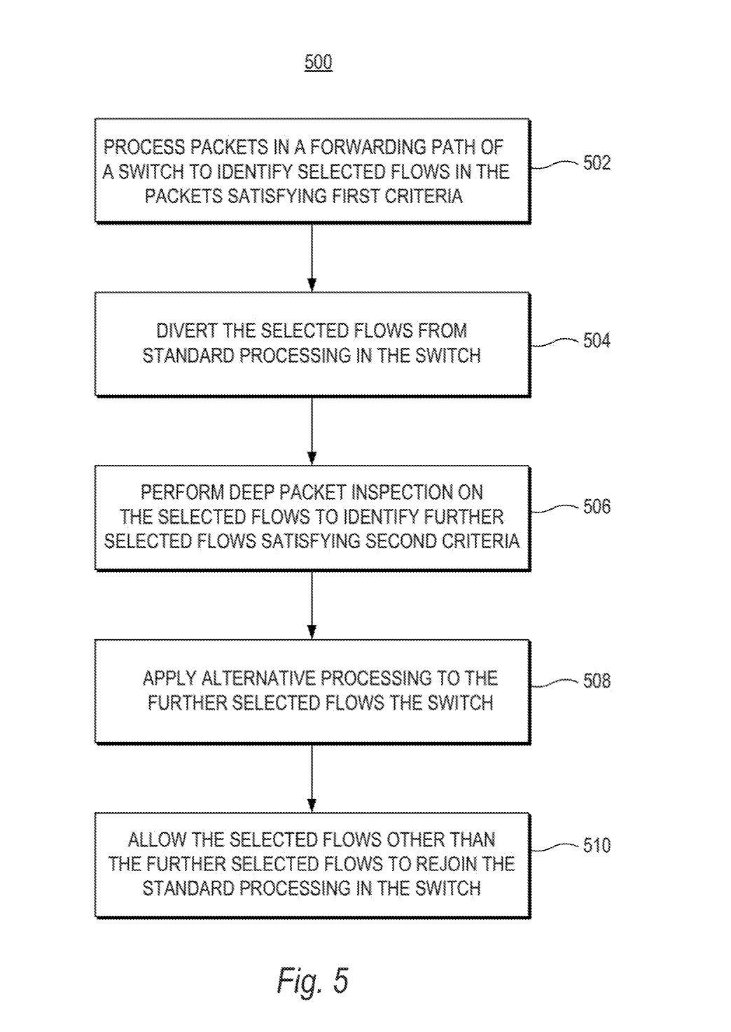

FIG. 5 is a flow diagram depicting a method 500 of packet inspection in a network device according to an example implementation. The method 500 begins at step 502, where packets in a forwarding path of a switch are processed to identify selected flows in the packets satisfying a first criteria. Step 502 represents a first tier of packet inspection. At step 504, the selected flows are diverted from standard processing in the switch. At step 506, deep packet inspection is performed on the selected flows to identify further selected flows that satisfy second criteria. Step 506 represents at least one additional tier of packet inspection. At step 508, alternative processing is applied to the further selected flows in the switch. At step 510, the selected flows other than the further selected flows are allowed to rejoin the standard processing in the switch.

in an example, step 502 includes matching the packets against patterns and identifying any of the packets that match a threshold number of the patterns as selected flows. In an example, the patterns can include byte patterns and/or packet patterns and/or regular expressions. In an example, step 506 includes applying the selected flows against DPI functions and identifying any of the selected flows that fail a threshold number of the DPI tests as further selected flows. In an example, step 506 includes performing portions of the deep packet inspection on the selected flows over successive tiers of processing.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc., just to name a few. Other new and various types of computer-readable media may be used to store machine readable code discussed herein. Additionally, the techniques described may also be embodied in Application Specific Integrated Circuits (ASICs), Field Programmable Gate Arrays (FPGAs), and the like.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus to provide packet inspection in a network device, comprising:
a first stage circuit to monitor packets being switched by a network interface in the network device, the first stage circuit including at least one pattern matcher to identify selected flows in the packets satisfying first criteria and to divert the selected flows from standard processing in the network interface; and
a second stage circuit to receive the selected flows, to perform deep packet inspection on the selected flows to identify further selected flows satisfying a second criteria, and to control the network interface to apply alternative processing to the further selected flows and allow the selected flows other than the further selected flows to rejoin the standard processing.

2. The apparatus of claim 1, wherein the first stage circuit is in a forwarding path of the network interface.

3. The apparatus of claim 1, wherein the second stage circuit includes at least one deep packet inspection circuit to perform the deep packet inspection of the selected flows.

4. The apparatus of claim 1, wherein the at least one pattern matcher matches the packets against at least one of byte patterns, packet patterns, or regular expressions.

5. The apparatus of claim 1, the at least one pattern matcher matches the flows against patterns, the first criteria including a match with at least one of the patterns, and wherein the deep packet inspection includes tests, the second criteria including a match with test criteria.

6. A network device, comprising:
ports to receive and transmit packet flows;
at least one switch node to switch packets among the ports, each of the at least one switch node including a packet filter to identify selected packet flows satisfying first criteria, each of the at least one switch node diverting the selected packet flows from being switched based on standard policy;
at least one other switch node to receive the selected packet flows; and
at least one network processor, coupled to the at least one other switch node, to perform deep packet inspection on the selected packet flows to identify further selected packet flows satisfying second criteria, and to allow switching of the selected packet flows other than the further selected packet flows based on the standard policy, and process the further selected packet flows based on alternative policy.

7. The network device of claim 6, wherein the alternative policy data dictates to block switching of the further selected packet flows among the ports.

8. The network device of claim 6, wherein the alternative policy data dictates to redirect or mirror the further selected packet flows to at least one specified port of the ports.

9. The network device of claim 6, wherein the at least one network processor includes a plurality of network processors, each of the plurality of network processors to perform a portion of the deep packet inspection.

10. The network device of claim 6, wherein the at least one network processor includes a plurality of network processors, each of the plurality of network processors to perform the deep packet inspection on a portion of the selected packet flows.

11. The network device of claim 6, wherein the packet filter includes at least one pattern matcher to match the packet flows against patterns, the first criteria including a match with at least one of the patterns, and wherein the deep packet inspection includes a plurality of tests, the second criteria including a match with test criteria.

12. A method of packet inspection in a network device, comprising:
processing packets in a forwarding path of a switch to identify selected flows in the packets satisfying a first criteria;
diverting the selected flows from standard processing in the switch;
performing deep packet inspection on the selected flows to identify further selected flows satisfying a second criteria;
applying alternative processing to the further selected flows in the switch; and
allowing the selected flows other than the further selected flows to rejoin the standard processing in the switch.

13. The method of claim 12, wherein the step of processing the packets comprises:
matching the packets against patterns; and
identifying any of the packets that match a threshold number of the patterns as the selected flows.

14. The method of claim 3, wherein the patterns include at least one of byte patterns, packet patterns, or regular expressions.

15. The method of claim 12, wherein the step of performing the deep packet inspection comprises:
applying the selected flows against deep packet inspection tests; and
identifying any of the selected flows that match a threshold number of the deep packet inspection tests as the further selected flows.
